(19) United States
(12) Patent Application Publication
(10) Pub. No.: US 2023/0339402 A1
(43) Pub. Date: Oct. 26, 2023

(54) SELECTIVELY UTILIZING MULTIPLE IMAGING DEVICES TO MAINTAIN A VIEW OF AN AREA OF INTEREST PROXIMATE A WORK VEHICLE

(71) Applicant: Deere & Company, Moline, IL (US)

(72) Inventors: Brett S. Graham, Dubuque, IA (US); Giovanni A. Wuisan, Epworth, IA (US); Rachel Bruflodt, Dubuque, IA (US)

(21) Appl. No.: 17/725,749

(22) Filed: Apr. 21, 2022

(51) Int. Cl. B60R 1/27; B60R 1/28; B60R 11/04; H04N 7/18; G06T 7/73

(52) U.S. Cl. CPC B60R 1/27; B60R 1/28; B60R 11/04; H04N 7/181; G06T 7/73; B60R 2300/105; B60K 2370/176

(57) ABSTRACT

A method is provided for visually representing an area of interest proximate to or otherwise associated with a work vehicle including a first portion including a frame, an operator cab supported by the frame, and a second portion (e.g., boom assembly) moveable relative to the frame. The area of interest is at least partially obscured from an operator during movement of the second portion. First and second imaging devices are mounted on the work vehicle, at least one of the imaging devices having a field of view including the area of interest at any given time throughout movement of the second portion. The method includes selectively providing image data corresponding to the area of interest from either the first or the second imaging device to a display unit, wherein a display of the area of interest is substantially maintained thereon throughout the movement of the second portion.

### FIELD OF THE DISCLOSURE

The present disclosure relates to self-propelled work vehicles configured to provide improved operational awareness for human operators thereof. More particularly, the present disclosure relates to systems and methods for automatically maintaining a field of view including an area of interest relative to the work vehicle regardless of the position of a moveable implement or other vehicle portion relative to a main frame of the work vehicle.

### BACKGROUND

Work vehicles as discussed herein relate primarily to skid steer loaders and compact track loaders for reasons as further described below, but may in various embodiments apply as well to other work vehicles having boom assemblies or an equivalent thereof which are moved during operation to modify the terrain or equivalent working environment in some way, and more particularly which at least partially obscure a field of view for an operator during said movements.

There is an ongoing need in the field of such work vehicles for solutions that provide better operational awareness for the operator. One problem for the operator is that even in ideal circumstances the surroundings of the work vehicle can only be seen to a limited extent from the operator cab, and at various times throughout a trajectory of movement for a portion of the work vehicle such as for example a pivoting, telescoping, or articulating work implement (e.g., boom assembly) the operator's field of view of the terrain to the sides of the work vehicle may be almost entirely obscured. While this may not be problematic for certain work vehicles, skid steer loaders and compact track loaders are primary examples of a work vehicle wherein at least part of the boom assembly traverses what otherwise would be the field of view of for an operator to either side of the work vehicle with respect to a traveling direction thereof. Consequently, the operator may be unable to sufficiently identify external objects from a typical working position that are concealed by the work implement in his field of vision.

### BRIEF SUMMARY OF THE DISCLOSURE

The current disclosure provides an enhancement to conventional systems, at least in part by mounting a detection system (i.e., including a plurality of imaging devices such as cameras, lidar sensors, and the like) in association with the work vehicle in such a manner that a field of view for a predetermined area of interest to one or more sides of the work vehicle is maintained throughout a trajectory of movement for the boom assembly thereof.

According to a first embodiment, a method is disclosed herein for visually representing an area of interest proximate to or otherwise associated with a work vehicle which comprises: a first portion comprising a frame supported by a plurality of ground engaging units; an operator cab supported by the frame and having one or more fields of view there from; a second portion moveable relative to the first portion, wherein the area of interest is at least partially obscured by the second portion via the one or more fields of view from the operator cab during at least part of a trajectory of movement of the second portion; and at least a first imaging device and a second imaging device mounted on the work vehicle, wherein at least one of the first and second imaging devices has a field of view including the area of interest at any given time throughout the trajectory of movement of the second portion. The method includes at least a step of selectively providing image data corresponding to the area of interest from one of the at least first imaging device and second imaging device to a display unit, wherein a display of the area of interest is substantially maintained thereon throughout the trajectory of movement of the second portion. The display unit may be part of a user interface associated with the work vehicle and located in the operator cab, part of a mobile device associated with an operator of the work vehicle, remotely located with respect to the work vehicle, or the like.

In a second embodiment, an exemplary further aspect according to the above-referenced first embodiment may include that image data are continuously generated from each of the at least first imaging device and second imaging device, and the method comprises selecting image data from one of the at least first imaging device and second imaging device based on a determined position of the second portion of the work vehicle along the trajectory of movement of the second portion.

In a third embodiment, an exemplary further aspect according to the above-referenced first embodiment may include the at least first imaging device and second imaging device are selectively activated to generate respective image data to the display unit based on a determined position of the second portion of the work vehicle along the trajectory of movement of the second portion.

In a fourth embodiment, further exemplary aspects according to any of the above-referenced first to third embodiments may include visually representing a top down view of the area of interest on the display unit, based at least in part on the image data from the at least first and second imaging devices.

In a fifth embodiment, further exemplary aspects according to any of the above-referenced first to fourth embodiments may include determining the position of the second portion of the work vehicle along the trajectory of movement of the second portion in a local reference system via at least signals from one or more kinematic sensors. At least one of the one or more kinematic sensors may for example be integrated in the first imaging device or the second imaging device.

In a sixth embodiment, a work vehicle as disclosed herein comprises: a first portion comprising a frame supported by a plurality of ground engaging units; an operator cab supported by the frame and having one or more fields of view there from; a second portion moveable relative to the first portion, wherein the area of interest is at least partially obscured by the second portion via the one or more fields of view from the operator cab during at least part of a trajectory of movement of the second portion; at least a first imaging device and a second imaging device mounted on the work vehicle, wherein at least one of the first and second imaging devices has a field of view including the area of interest at any given time throughout the trajectory of movement of the second portion; a display unit; and a controller configured to direct the performance of steps in a method according to any one or more of the first to fifth embodiments.

In a seventh embodiment, further exemplary aspects according to the above-referenced sixth embodiment may include that the first imaging device is mounted to the frame of the work vehicle at a first location, and the second imaging device is mounted to the frame of the work vehicle at a second location, wherein the second location is below the first location during travel of the work vehicle across terrain.

In an eighth embodiment, further exemplary aspects according to the above-referenced seventh embodiment may include that the controller is configured to determine whether the first imaging device has a field of view including the area of interest at any given time throughout the trajectory of movement of the second portion, and further to select image data from the first imaging device at all times when the respective field of view includes the area of interest.

In a ninth embodiment, further exemplary aspects according to the above-referenced seventh embodiment may include that the controller is configured to determine whether the first imaging device has a field of view including the area of interest at any given time throughout the trajectory of movement of the second portion, and further to activate the first imaging device at all times when the field of view of the first imaging device includes the area of interest and to deactivate the first imaging device and activate the second imaging device at all times when the field of view of the first imaging device does not include the area of interest.

In a tenth embodiment, further exemplary aspects according to the above-referenced sixth embodiment may include that the first imaging device is mounted to the first portion of the work vehicle, and the second imaging device is mounted to the second portion of the work vehicle.

In an eleventh embodiment, further exemplary aspects according to the above-referenced tenth embodiment may include that the controller is configured to determine whether the first imaging device has a field of view including the area of interest at any given time throughout the trajectory of movement of the second portion, and further to select image data from the first imaging device at all times when the respective field of view includes the area of interest.

In a twelfth embodiment, further exemplary aspects according to the above-referenced tenth embodiment may include that the controller is configured to determine whether the first imaging device has a field of view including the area of interest at any given time throughout the trajectory of movement of the second portion, and further to activate the first imaging device at all times when the field of view of the first imaging device includes the area of interest and to deactivate the first imaging device and activate the second imaging device at all times when the field of view of the first imaging device does not include the area of interest.

In a thirteenth embodiment, further exemplary aspects according to the above-referenced tenth to twelfth embodiments may include that the second imaging device comprises a zoom lens, and the controller is further configured to automatically adjust a zoom setting based at least in part on a current position of the second imaging device along the trajectory of movement of the second portion of the work vehicle. The second imaging device may for example be coupled to the second portion of the work vehicle via a rotatable mount, and the controller may further be configured to automatically adjust rotation and accordingly an orientation of the second imaging device based at least in part on a current position of the second imaging device along the trajectory of movement of the second portion of the work vehicle.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view of an embodiment of a skid-steer loader as a work vehicle according to the present disclosure.

FIGS. 2A to 2D are side views representing an embodiment of the skid-steer loader having imaging devices mounted in a first exemplary configuration as disclosed herein, and with the boom assembly of the work vehicle in different states throughout an available trajectory of movement.

FIGS. 3A to 3C are side views representing an embodiment of the skid-steer loader having imaging devices mounted in a second exemplary configuration as disclosed herein, and with the boom assembly of the work vehicle in different states throughout an available trajectory of movement.

FIG. 4 is a graphical diagram representing an exemplary control system for a work vehicle of the present disclosure.

FIG. 5 is a flowchart representing an exemplary method according to the present disclosure.

### DETAILED DESCRIPTION

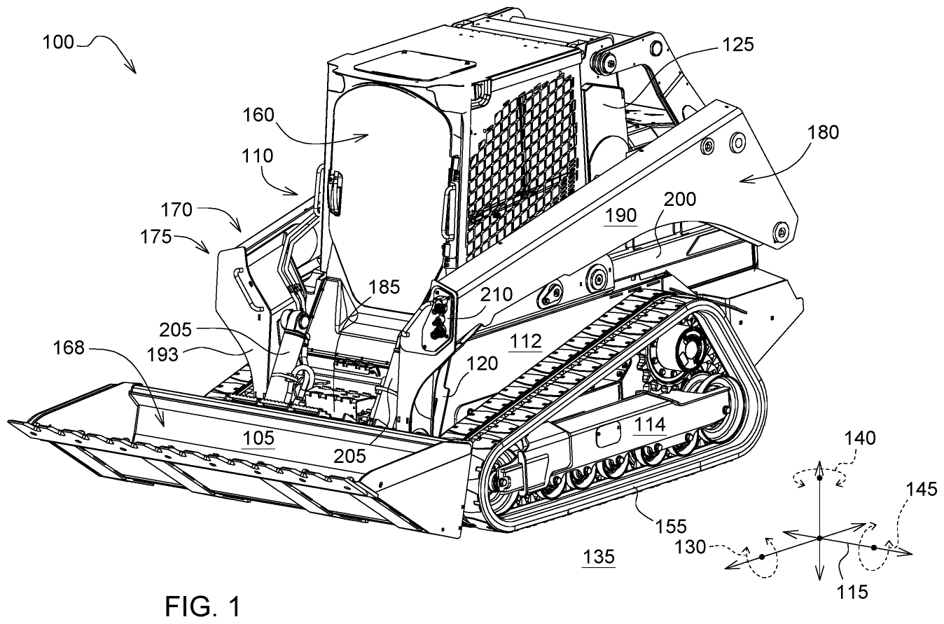

Referring now to the drawings and particularly to FIG. 1, a representative work vehicle is shown and generally designated by the number 100. A work vehicle 100 may also be described herein as a “work machine” or “machine” without explicit limitation to the scope thereof, or otherwise implying a self-propelled or other such feature to the relevant structure. FIG. 1 shows a compact track loader, but it may be understood that the work vehicle 100 could be one of many types of work vehicles, including, and without limitation, a skid steer loader, a backhoe loader, a front loader, a bulldozer, and other construction vehicles, having distinctions in their respective components with respect to the compact track loader and as may be appreciate by one of skill in the art. The work vehicle 100, as shown, has a frame 110 extending in a fore-aft direction 115 with a front-end section 120 and a rear-end section 125. The work vehicle includes a ground-engaging mechanism 155 that supports the frame 110 and an operator cab 160 supported on the frame 110, wherein the ground-engaging mechanism 155 is configured to support the frame 110 on a surface 135.

An engine 165 (not shown) is coupled to the frame 110 and is operable to move the work vehicle 100. The illustrated work vehicle includes tracks, but other embodiments can include one or more wheels that engage the surface 135. The work vehicle 100 may be operated to engage the surface 135 and cut and move material to achieve simple or complex features on the surface. As used herein, directions with regard to work vehicle 100 may be referred to from the perspective of an operator seated within the operator cab 160; the left of work vehicle 100 is to the left of such an operator, the right of work vehicle is to the right of such an operator, the front or fore of work vehicle is the direction such an operator faces, the rear or aft of work vehicle is behind such an operator, the top of work vehicle is above such an operator, and the bottom of work vehicle below such an operator. In order to turn, the ground-engaging mechanism 155 on the left side of the work vehicle may be operated at a different speed, or in a different direction, from the ground-engaging mechanism 155 on the right side of the work vehicle 100. In a conventional compact track loader, the operator can manipulate controls from inside an operator cab 160 to drive the tracks on the right or left side of the work vehicle 100. Rotation for work vehicle may be referred to as roll 130 or the roll direction, pitch 145 or the pitch direction, and yaw 140 or the yaw direction.

The work vehicle 100 comprises a boom assembly 170 coupled to the frame 110. An attachment 105, or work tool, may be pivotally coupled at a forward portion 175 of the boom assembly 170, while a rear portion 180 of the boom assembly 170 is pivotally coupled to the frame 110. The frame 110 as represented comprises a main frame 112 and a track frame 114. The attachment 105 is illustrated as a bucket, but may further or alternatively be any number of work tools such as a blade, forks, an auger, a drill, or a hammer, just to name a few possibilities. The attachment 105 may be coupled to the boom assembly 170 through an attachment coupler 185 which may be coupled to a distal section of the lift arms 190, or more specifically a portion of the boom arms in the forward portion 175 of the boom assembly 170.

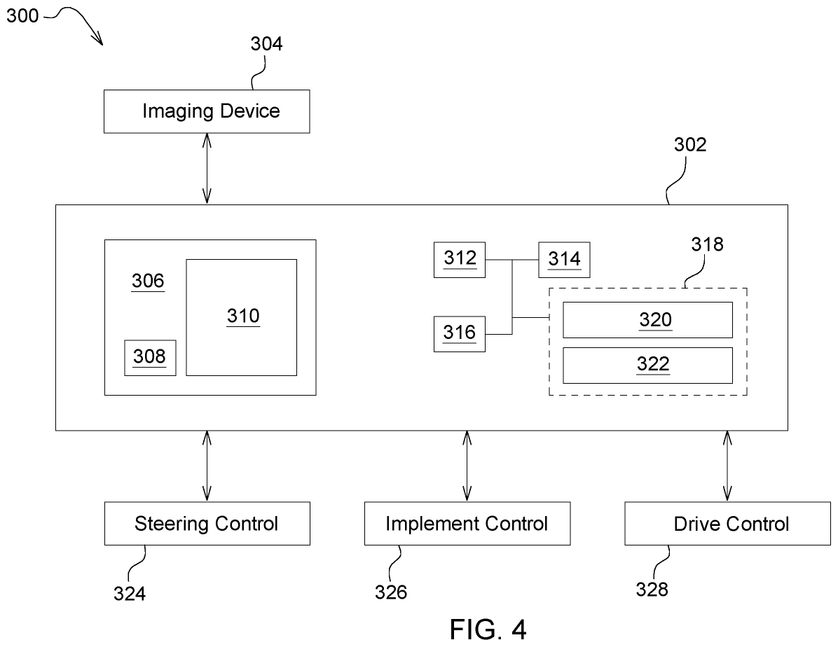

The boom assembly 170 comprises a first pair of lift arms 190 pivotally coupled to the frame 110 (one each on a left side and a right side of the operator cab 160) and moveable relative to the frame 110 by a pair of first hydraulic cylinders 200, wherein the pair of first hydraulic cylinders 200 may also conventionally be referred to as a pair of lift cylinders (one coupled to each boom arm) for a compact track loader. The attachment coupler 185 may be coupled to a forward section 193 of the pair of lift arms 190, being moveable relative to the frame 110 by a pair of second hydraulic cylinders 205, which may be referred to as tilt cylinders for a compact track loader. The frame 110 of the work vehicle 100 further comprises a hydraulic coupler 210 on the front-end portion 120 of the work vehicle 100 to couple one or more auxiliary hydraulic cylinders (not shown) to drive movement of or actuate auxiliary functions of an attachment 105. The attachment coupler 185 enables the mechanical coupling of the attachment 105 to the frame 110. The hydraulic coupler 210, contrary to the attachment coupler 185, enables the hydraulic coupling of an auxiliary hydraulic cylinder(s) on the attachment 105 to the hydraulic (implement control) system 326 (see FIG. 4) of the work vehicle 100. It may be understood that not all attachments will have one or more auxiliary hydraulic cylinders and therefore may not use the hydraulic coupler 210. In the configuration represented in FIG. 1, wherein a bucket 168 is coupled to a compact track loader as the working tool 105, the bucket does not use the hydraulic coupler or have auxiliary hydraulic cylinders. Alternatively, for example, the hydraulic coupler 210 may open or close a grapple type attachment, or spin a roller brush type attachment.

Each of the pair of first hydraulic cylinders 200, the pair of second hydraulic cylinders 205, and any auxiliary cylinders if applicable when found on the attachment 105 may be double acting hydraulic cylinders. One end of each cylinder may be referred to as a head end, and the end of each cylinder opposite the head end may be referred to as a rod end. Each of the head end and the rod end may be fixedly coupled to another component, such as a pin-bushing or pin-bearing coupling, to name but two examples of pivotal connections. As a double acting hydraulic cylinder, each may exert a force in the extending or retracting direction. Directing pressurized hydraulic fluid into a head chamber of the cylinders will tend to exert a force in the extending direction, while directing pressurized hydraulic fluid into a rod chamber of the cylinders will tend to exert a force in the retracting direction. The head chamber and the rod chamber may both be located within a barrel of the hydraulic cylinder, and may both be part of a larger cavity which is separated by a moveable piston connected to a rod of the hydraulic cylinder. The volumes of each of the head chamber and the rod chamber change with movement of the piston, while movement of the piston results in extension or retraction of the hydraulic cylinder.

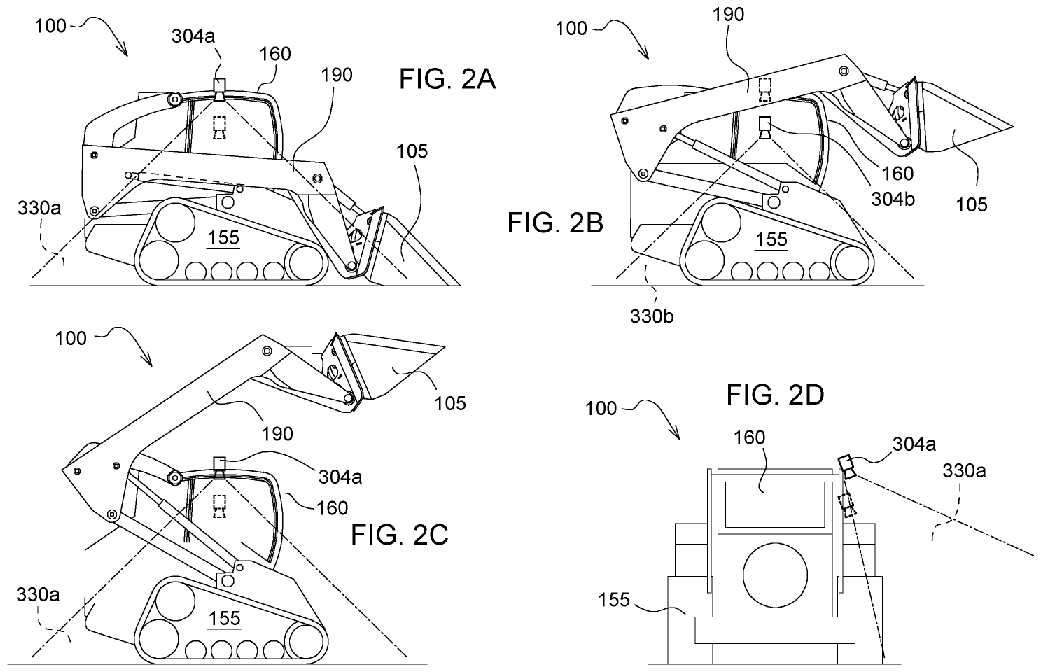

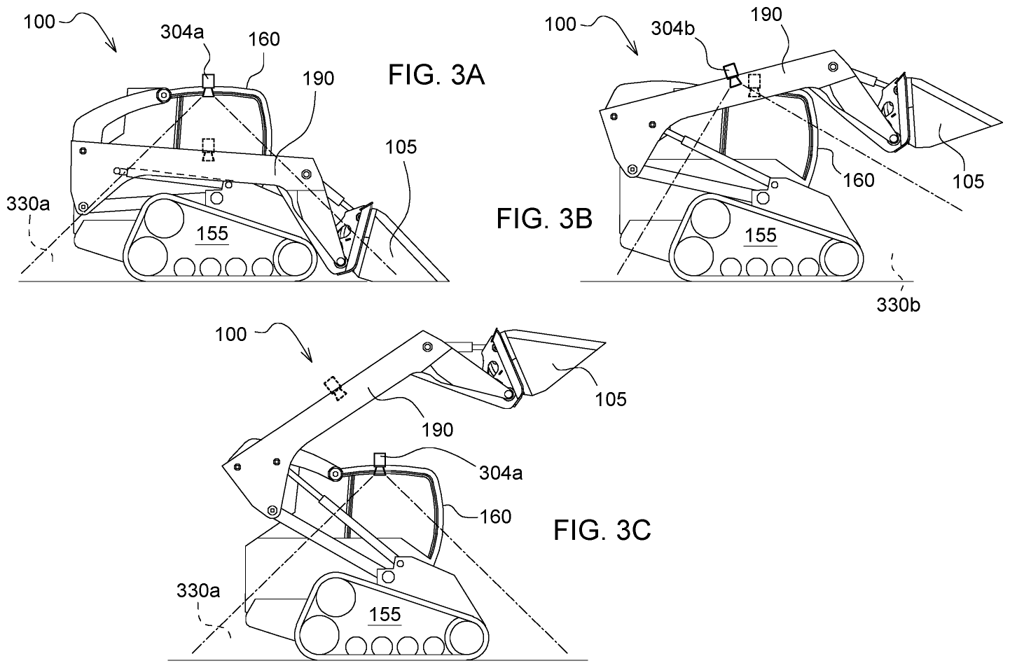

For a work vehicle 100 as represented in FIG. 1, and further in view of the different potential positions of the boom assembly 170 and more particularly the lift arms 190 thereof throughout an available trajectory of movement (see, e.g., FIGS. 2-3), it may be understood that the boom assembly 170 at least partially obscures a lateral field of view from an operator when seated in the operator cab 160 during various portions of the available trajectory of movement.

In an embodiment as further represented in FIGS. 2A-2D, a first imaging device 304a is mounted at a first location on the work vehicle 100, in this case mounted to the frame and above the lateral field of view of the operator cab 160. A second imaging device 304b is further mounted at a second location on the work vehicle 100, in this case also mounted to the frame and directly below the first imaging device 304a. In such an embodiment or various equivalents thereof, both of the imaging devices 304a, 304b may be characterized as being mounted to a first portion associated with the frame of the work vehicle 100, and not to a second portion associated with the boom assembly or otherwise moveable relative to the first portion.

In another exemplary embodiment as further represented in FIGS. 3A-3C, a first imaging device 304a is mounted at a first location on the work vehicle 100, in this case as with the previously discussed embodiment mounted to the frame 110 and above the lateral field of view of the operator cab 160. A second imaging device 304b is further mounted at a second location on the work vehicle 100, in this case mounted to the boom assembly 170 of the work vehicle rather than the frame 110. In such an embodiment or various equivalents thereof, the first imaging device 304a may be characterized as being mounted to a first portion associated with the frame 110 of the work vehicle 100, and not to a second portion associated with the boom assembly or otherwise moveable relative to the first portion, whereas the second imaging device 304b is mounted to the second portion of the work vehicle 100.

In the above-referenced embodiments wherein the work vehicle 100 is a skid steer or compact track loader, a first portion of the work vehicle 100 may be defined as including the main frame 110 whereas a second portion of the work vehicle includes at least the boom assembly 170 which is supported from and moveable relative to the frame 110. In various alternative embodiments as previously noted (not shown in the figures), the work vehicle 100 may be an excavator, a crawler dozer, an articulated dump truck, or the like. In the case of an excavator, for example, the first portion of the work vehicle 100 includes the frame supporting the operator cab while the second portion includes the boom assembly supported by the frame but forwardly and centrally extending, such that the boom assembly obscures visibility from a different perspective than with the compact track loader, for example. As another non-limiting example, the imaging device may for example be mounted on either portion of an articulating vehicle such as a dump truck.

As schematically illustrated in FIG. 3, the work vehicle 100 includes a control system 300 including a controller 302. The controller 302 may be part of the vehicle control unit, or it may be a separate control module. The controller 302 may include the user interface 306 and optionally be mounted in the operators cab 160 at a control panel.

The controller 302 is configured to receive input signals from the imaging devices 304a, 304b. The output signals from the respective imaging devices 304a, 304b may be provided directly to the controller 302 or for example via intervening components for analog-to-digital conversion and/or video interface (not shown). Certain additional sensors (not shown) may be functionally linked to the controller 302 and provided to detect vehicle operating conditions and/or kinematics. In an embodiment, such as for example where the second imaging device 304b is mounted on the boom assembly 170 or another moveable second portion of the work vehicle relative to the first portion (i.e., frame), at least one kinematics sensor such as a rotary sensor may be provided for tracking a position of the second imaging device 304b relative to a predetermined area of interest.

In a particular exemplary embodiment, vehicle kinematics sensors for tracking a position of the imaging device 304 relative to a predetermined area of interest may be provided in the form of inertial measurement units (each, an IMU) integrated within the imaging device 304 and/or separately mounted on at least the frame 110 of the work vehicle 100, and further on the lift arm 190 or other relevant component upon which the imaging device 304 is mounted. IMUs include a number of sensors including, but not limited to, accelerometers, which measure (among other things) velocity and acceleration, gyroscopes, which measure (among other things) angular velocity and angular acceleration, and magnetometers, which measure (among other things) strength and direction of a magnetic field. Generally, an accelerometer provides measurements, with respect to (among other things) force due to gravity, while a gyroscope provides measurements, with respect to (among other things) rigid body motion. The magnetometer provides measurements of the strength and the direction of the magnetic field, with respect to (among other things) known internal constants, or with respect to a known, accurately measured magnetic field. The magnetometer provides measurements of a magnetic field to yield information on positional, or angular, orientation of the IMU; similarly to that of the magnetometer, the gyroscope yields information on a positional, or angular, orientation of the IMU. Accordingly, the magnetometer may be used in lieu of the gyroscope, or in combination with the gyroscope, and complementary to the accelerometer, in order to produce local information and coordinates on the position, motion, and orientation of the IMU.

In another embodiment, non-kinematic sensors may be implemented for position detection, such as for example markers or other machine-readable components that are mounted or printed on the work vehicle 100 and within the field of view of either or both of the imaging devices 304a, 304b, and more particularly the second imaging device 304b when considered in the context of the embodiment as represented in FIGS. 3A to 3C. In one example, April tags or an equivalent may be provided such that, depending on how the marker appears within the field of view of the second imaging device 304b, data processing elements may calculate a distance to the marker and/or orientation of the marker relative to the second imaging device 304b for spatially ascertaining the position of the second imaging device 304b. As another example, machine learning techniques may be implemented based on inputs for two or more known components of the work vehicle 100 such as a front cab mount and a rear mudguard, such that the data processing units can spatially ascertain a position of the second imaging device 304b based on a distance between the two or more components and their respective positions in the field of view of the second imaging device 304b.

Other sensors functionally linked to the controller 302 which may optionally be provided for functions as described herein or otherwise may include for example global positioning system (GPS) sensors, vehicle speed sensors, ultrasonic sensors, laser scanners, radar wave transmitters and receivers, thermal sensors, imaging devices, structured light sensors, and other optical sensors, and whereas one or more of these sensors may be discrete in nature a sensor system may further refer to signals provided from a central machine control unit.

The imaging devices 304am, 304b may include video cameras configured to record an original image stream and transmit corresponding data to the controller 302. In the alternative or in addition, the imaging devices 304a, 304b may include one or more of a digital (CCD/CMOS) camera, an infrared camera, a stereoscopic camera, a time-of-flight/depth sensing camera, high resolution light detection and ranging (LiDAR) scanners, radar detectors, laser scanners, and the like within the scope of the present disclosure. The number and orientation of said imaging devices 304a, 304b or respective sensors may vary in accordance with the type of work vehicle 100 and relevant applications, but may at least be provided with respect to a field of view 330 alongside the work vehicle 100 and configured to capture data associated with lateral surroundings and associated objects proximate thereto.

In an embodiment, either or both of the imaging devices 304a, 304b may include an ultra-wide-angle lens (e.g., a “fish-eye” lens) having a sufficiently broad field of view to capture an area of interest at any position along an available trajectory of movement (if any) of a component upon which the imaging device 304b is mounted, and to provide image data comprising the area of interest projected on a plane for image data processing functions as further described elsewhere herein. Either or both of the imaging devices 304a, 304b may be provided with a zoom lens such that the field of view and correspondingly the output image data from a respective imaging device compensates for movement of the position of the imaging device relative to the area of interest. Such an embodiment may eliminate or at least reduce the need for data processing downstream of the imaging device to resize the field of view, for example where the scale of the resultant image may otherwise vary depending on the relative heights of the imaging devices as they transition there between during operation as further described below.

In an embodiment wherein the second imaging device 304b is mounted on a second portion as previously described, it may be contemplated that the second imaging device 304b is provided with a moveable/rotatable mount such that the field of view is dynamic to correspond with an area of interest throughout movement of the component upon which the second imaging device 304b is mounted for at least the portion of the trajectory in which the image data from the second imaging device 304b is selected or otherwise during which the second imaging device 304 is activated.

It may of course be understood that one or more of the preceding embodiments with respect to the first and/or second imaging devices 304a, 304b may be combined to provide corresponding features for a method as described below. For example, a zoom lens may be provided along with a panning base such that either or both of the imaging devices are continuously directed to the same area of interest throughout movement (if any) of the element of the work vehicle 100 to which the imaging devices are mounted.

One of skill in the art may appreciate that image data processing functions may be performed discretely at a given imaging device 304a, 304b if properly configured, but most if not all image data processing may generally be performed by the controller 302 or other downstream data processor. For example, image data from either or both of the imaging devices 304a, 304b may be provided for three-dimensional point cloud generation, image segmentation, object delineation and classification, and the like, using image data processing tools as are known in the art in combination with the objectives disclosed.

The controller 302 of the work vehicle 100 may be configured to produce outputs, as further described below, to a user interface 306 associated with a display unit 310 for display to the human operator. The controller 302 may be configured additionally or in the alternative to produce outputs to a display unit independent of the user interface 306 such as for example a mobile device associated with the operator or a remote display unit independent of the work vehicle 100. The controller 302 may be configured to receive inputs from the user interface 306, such as user input provided via the user interface 306. Not specifically represented in FIG. 3, the controller 302 of the work vehicle 100 may in some embodiments further receive inputs from remote devices associated with a user via a respective user interface, for example a display unit with touchscreen interface. Data transmission between for example the vehicle control system and a remote user interface may take the form of a wireless communications system and associated components as are conventionally known in the art. In certain embodiments, a remote user interface and vehicle control systems for respective work vehicles may be further coordinated or otherwise interact with a remote server or other computing device for the performance of operations in a system as disclosed herein.

The controller 302 may be configured to generate control signals for controlling the operation of respective actuators, or signals for indirect control via intermediate control units, associated with a machine steering control system 324, a machine implement control system 326, and/or a machine drive control system 328. The controller 302 may for example be electrically coupled to respective components of these and/or other systems by a wiring harness such that messages, commands, and electrical power may be transmitted between the controller 302 and the remainder of the work vehicle 100. The controller 302 may be coupled to other controllers, such as for example the engine control unit (ECU), through a controller area network (CAN), and may then send and receive messages over the CAN to communicate with other components of the CAN.

The controller 302 may include or be associated with a processor 312, a computer readable medium 314, a communication unit 316, data storage 318 such as for example a database network, and the aforementioned user interface 306 or control panel 306 having a display 310. An input/output device 308, such as a keyboard, joystick or other user interface tool, is provided so that the human operator may input instructions to the controller. It is understood that the controller described herein may be a single controller having all of the described functionality, or it may include multiple controllers wherein the described functionality is distributed among the multiple controllers.

Various operations, steps or algorithms as described in connection with the controller 302 can be embodied directly in hardware, in a computer program product such as a software module executed by the processor 312, or in a combination of the two. The computer program product can reside in RAM memory, flash memory, ROM memory, EPROM memory, EEPROM memory, registers, hard disk, a removable disk, or any other form of computer-readable medium 314 known in the art. An exemplary computer-readable medium can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” 312 as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The communication unit 316 may support or provide communications between the controller and external systems or devices, and/or support or provide communication interface with respect to internal components of the work vehicle. The communications unit may include wireless communication system components (e.g., via cellular modem, WiFi, Bluetooth or the like) and/or may include one or more wired communications terminals such as universal serial bus ports.

The data storage 318 in an embodiment may be configured to at least receive and store real-time and/or historical data sets regarding machine parameters 320 and real-time and/or historical data sets regarding image data parameters 322 in selectively retrievable form, for example as inputs for developing models as further described herein for correlating positions of the boom assembly and a preferred imaging device 304a, 304b to be activated or otherwise implemented for display purposes. Data storage as discussed herein may, unless otherwise stated, generally encompass hardware such as volatile or non-volatile storage devices, drives, memory, or other storage media, as well as one or more databases residing thereon.

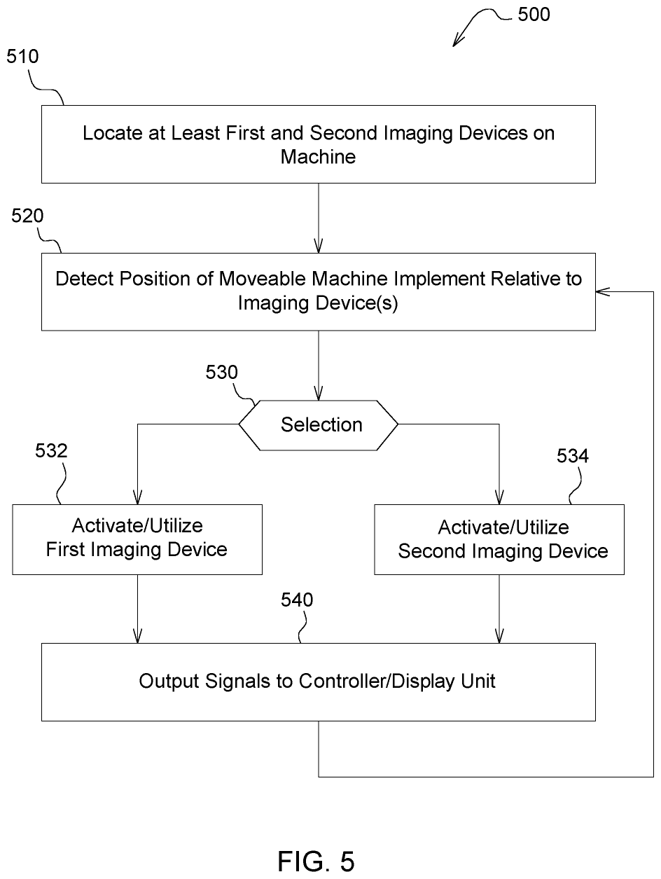

Referring next to FIG. 5, an exemplary method 500 of visually representing at least an area of interest, which may for example be a portion of terrain proximate to a work vehicle 100, may now be described. A first step 510 as represented involves locating at least a first imaging device 304a and a second imaging device 304b on the machine/work vehicle 100, wherein a second step 520 involves detecting a position of a moveable work implement 170 relative to either or both of the imaging devices. As previously noted, the scope of an invention as disclosed herein is not limited to a moveable work implement 170 such as a boom assembly, but may also encompass steps as further described below with respect to a moveable second portion of the work vehicle 100 relative to a first portion (e.g., frame) of the work vehicle 100 without specific reference to a work implement.

A controller 302 may in step 530 select which of the first imaging device 304a or the second imaging device 304b is appropriately utilized based on the detected position of the work implement/second portion of the work vehicle 100 relative to the frame/first portion. Depending on the selection, the controller 302 may further direct image data output signals from one of the imaging devices 304a, 304b (in step 532 or step 534) to be directed for example to a display unit or back to the controller for further image processing and transmittal to the display unit (step 540). It may be understood, as previously noted above, that the controller 302 may select from among multiple image data streams for display purposes, or may selectively activate a given imaging device from among the available imaging devices 304, either being within the scope of the present disclosure and depending for example on how the controller is programmed for a particular work vehicle implementation.

In an embodiment as represented in FIGS. 2A to 2D, a first imaging device 304a is mounted at a first location relative to the operator cab 160 and a second imaging device 304b is mounted at a second location relative to the operator cab 160. Both imaging devices 304a, 304b will remain static relative to the frame 110 throughout motion of the work vehicle 100 generally or more particularly with respect to the work implement 170.

As represented in FIG. 2A, when the work implement 170 is in a lowest position along the available trajectory of movement, e.g., with the work tool 105 engaging the ground, the field of view 330b for the second imaging device 304b may be effectively blocked with respect to the area of interest, which in this example is part of the terrain directly to the side of the ground engaging units 155 of the work vehicle 100. The first imaging device 304a has a field of view 330a which includes the area of interest and is therefore selected and/or activated, either by the controller 302 or independently in some embodiments, for implementation in this configuration of the work implement 170.

As represented in FIG. 2B, when the work implement 170 is in an intermediate position along the available trajectory of movement, the field of view 330a for the first imaging device 304a may be effectively blocked with respect to the area of interest. The second imaging device 304b however has a field of view 330b which includes the area of interest and is therefore selected and/or activated, either by the controller 302 or independently in some embodiments, for implementation in this configuration of the work implement 170.

As represented in FIG. 2C, when the work implement 170 is in a highest position along the available trajectory of movement, the respective fields of view 330a, 330b for each the first imaging device 304a and the second imaging device 304b may both include the area of interest. However, the first imaging device 304a may be favorably selected or activated over the second imaging device 304b because for example the higher mounting position of the first imaging device 304a enables a field of view 330a which is wider and therefore more effective for the desired purpose. It should be noted for each of the above-referenced examples that the transition between imaging devices 304a, 304b is in no way limited to the extremes described here (e.g., highest and lowest positions) and that the transitions may take place based on any number of triggers that are deemed appropriate for a given area of interest, work vehicle, work condition, or the like. For example, a transition from the first imaging device 304a to the second imaging device 304b may in some embodiments only be performed at such times as the first imaging device 304a is unable to capture the area of interest within its respective field of view 330a, with such a determination being made dynamically by the first imaging device 304a and/or by the controller 302 for a given area of interest (which may for example be adjusted during operation by the operator or other authorized entity), work conditions, conditions of the imaging devices 304a, 304b, etc.

In an embodiment as represented in FIGS. 3A to 3C, a first imaging device 304a is mounted on the first portion (e.g., frame 110) of the work vehicle and a second imaging device 304b is mounted on the second portion (e.g., on the work implement 170). The first imaging device 304a will remain static relative to the frame 110 throughout motion of the work vehicle 100, whereas the second imaging device 304b moves along with the work implement 170 throughout its available trajectory of movement.

As represented in FIG. 3A, when the work implement 170 is in a lowest position along the available trajectory of movement, e.g., with the work tool 105 engaging the ground, the respective fields of view 330a, 330b for each the first imaging device 304a and the second imaging device 304b may both include the area of interest. However, the first imaging device 304a may be favorably selected or activated over the second imaging device 304b because for example the higher mounting position of the first imaging device 304a enables a field of view 330a which is wider and therefore more effective for the desired purpose.

As represented in FIG. 3B, when the work implement 170 is in an intermediate position along the available trajectory of movement, the field of view 330a for the first imaging device 304a may be effectively blocked with respect to the area of interest. The second imaging device 304b however has a field of view 330b which includes the area of interest and is therefore selected and/or activated, either by the controller 302 or independently in some embodiments, for implementation in this configuration of the work implement 170.

As represented in FIG. 3C, when the work implement 170 is in a highest position along the available trajectory of movement, the respective fields of view 330a, 330b for each the first imaging device 304a and the second imaging device 304b may both include the area of interest. However, the first imaging device 304a may be favorably selected or activated over the second imaging device 304b because for example the area of interest may be more centrally disposed within the field of view 330a of the first imaging device 304a, whereas the area of interest takes up a smaller and more peripheral area within the field of view 330b of the second imaging device 304b and additional image processing may further be required for favorable display of the area of interest. As with the examples from FIGS. 2A to 2D, it should be noted for each of the examples shown in FIGS. 3A to 3C that the transition between imaging devices 304a, 304b is in no way limited to the extremes described here (e.g., highest and lowest positions) and that the transitions may take place based on any number of triggers that are deemed appropriate for a given area of interest, work vehicle, work condition, or the like. For example, a transition from the first imaging device 304a to the second imaging device 304b may in some embodiments only be performed at such times as the first imaging device 304a is unable to capture the area of interest within its respective field of view 330a, with such a determination being made dynamically by the first imaging device 304a and/or by the controller 302 for a given area of interest (which may for example be adjusted during operation by the operator or other authorized entity), work conditions, conditions of the imaging devices 304a, 304b, etc.

While an area of interest as described above may be substantially to the side of the work vehicle 100 and more particularly alongside the ground engaging units 155 thereof, it may be understood that an area of interest may take numerous alternative forms or be provided in numerous alternative locations, including for example locations and/or forms that are user selectable via an onboard user interface associated with the display unit. Such user selections and associated adjustments to the area of interest may likewise impact the determinations with respect to selections and/or activations of the respective first imaging device 304a and second imaging device 304b throughout relative movements of the second portion relative to the first portion of the work vehicle 100, based on the relative abilities of the imaging devices 304 to effectively capture the adjusted area of interest.

In embodiments wherein the second imaging device 304b is moveable relative to the frame 110 of the work vehicle 100 but the images therefrom are being utilized for display, input data from the second imaging device 304b may be processed to generate output signals corresponding to a representative display of the area of interest to a display unit 310, wherein image display parameters associated with perimeter contours of the area of interest are substantially maintained throughout the available trajectory of movement of the boom assembly 170. In other words, as the boom assembly 170 is raised from an initial (i.e., lowest) position to a highest position, the area of interest would comprise a progressively smaller proportion of the overall field of view 330b, whereas it is desired in such an embodiment to maintain a consistent display of the contours of the area of interest throughout such movement, and more particularly with respect to the otherwise consistent field of view 330a from the first imaging device 330a.

To facilitate such image processing, the method 500 may include (although not shown) receiving input signals from one or more kinematic sensors on the frame 110, work implement 170, and the like, and/or input signals from other components such as for example a central vehicle control unit or user interface, for the purpose of determining a position of the boom assembly 170 and the corresponding position of the second imaging device 304b as it travels along its available trajectory of movement (step 520). In an embodiment, models may be iteratively developed and trained over time so as for example to correlate respective identified positions of the boom assembly 170, etc., with respect to contours of a predetermined area of interest. In some cases, wherein the area of interest may be selectable or otherwise adjustable by users, alternative or additional models may be trained to provide appropriate corresponding image processing factors for a given position. Sufficiently trained models may then be retrievably selected for use based on a determined position in real time for dynamic image processing and compensation.

The image processing and corresponding output signals to the display unit according to at least the represented embodiment may further enable user selection from among a plurality of display views. For example, the user may be able to select a perspective view of the area of interest. As another example, the user may be able to select a top down or overhead view (also referred to herein as a bird's eye view) which includes at least the area of interest and may for example include output signals corresponding to at least imaging devices 304a, 304b on opposing sides of the work vehicle 100 and stitched together to form a single display. As another example, the user may be able to select a split view including the area of interest in at least a first portion of the display.

Thus it is seen that an apparatus and/or methods according to the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments, unless otherwise specifically stated.

What is claimed is:

1. A method of visually representing an area of interest proximate to or otherwise associated with a work vehicle,
wherein the work vehicle comprises:
a first portion comprising a frame supported by a plurality of ground engaging units;
an operator cab supported by the frame and having one or more fields of view there from;
a second portion moveable relative to the first portion, wherein the area of interest is at least partially obscured by the second portion via the one or more fields of view from the operator cab during at least part of a trajectory of movement of the second portion; and
at least a first imaging device and a second imaging device mounted on the work vehicle, wherein at least one of the first and second imaging devices has a field of view including the area of interest at any given time throughout the trajectory of movement of the second portion;
the method comprising:
selectively providing image data corresponding to the area of interest from one of the at least first imaging device and second imaging device to a display unit, wherein a display of the area of interest is substantially maintained thereon throughout the trajectory of movement of the second portion.

2. The method of claim 1, wherein image data are continuously generated from each of the at least first imaging device and second imaging device, and the method comprises selecting image data from one of the at least first imaging device and second imaging device based on a determined position of the second portion of the work vehicle along the trajectory of movement of the second portion.

3. The method of claim 1, wherein the at least first imaging device and second imaging device are selectively activated to generate respective image data to the display unit based on a determined position of the second portion of the work vehicle along the trajectory of movement of the second portion.

4. The method of claim 1, comprising visually representing a top down view of the area of interest on the display unit, based at least in part on the image data from the at least first and second imaging devices.

5. The method of claim 1, further comprising determining the position of the second portion of the work vehicle along the trajectory of movement of the second portion in a local reference system via at least signals from one or more kinematic sensors.

6. The method of claim 5, wherein at least one of the one or more kinematic sensors are integrated in the first imaging device or the second imaging device.

7. A work vehicle comprising:
a first portion comprising a frame supported by a plurality of ground engaging units;
an operator cab supported by the frame and having one or more fields of view there from;
a second portion moveable relative to the first portion, wherein the area of interest is at least partially obscured by the second portion via the one or more fields of view from the operator cab during at least part of a trajectory of movement of the second portion;
at least a first imaging device and a second imaging device mounted on the work vehicle, wherein at least one of the first and second imaging devices has a field of view including the area of interest at any given time throughout the trajectory of movement of the second portion;
a display unit; and
a controller configured to selectively provide image data corresponding to the area of interest from one of the at least first imaging device and second imaging device to the display unit, wherein a display of the area of interest is substantially maintained thereon throughout the trajectory of movement of the second portion.

8. The work vehicle of claim 7, wherein image data are continuously generated from each of the at least first imaging device and second imaging device, and the controller is configured to select image data from one of the at least first imaging device and second imaging device based on a determined position of the second portion of the work vehicle along the trajectory of movement of the second portion.

9. The work vehicle of claim 7, wherein the at least first imaging device and second imaging device are selectively activated to generate respective image data to the display unit based on a determined position of the second portion of the work vehicle along the trajectory of movement of the second portion.

10. The work vehicle of claim 7, wherein the controller is configured to generate display signals to the display unit representing a top down view of the area of interest, based at least in part on the image data from the at least first and second imaging devices.

11. The work vehicle of claim 7, wherein the controller is configured to determine the position of the second portion of the work vehicle along the trajectory of movement of the second portion in a local reference system via at least signals from one or more kinematic sensors.

12. The work vehicle of claim 11, wherein at least one of the one or more kinematic sensors are integrated in the first imaging device or the second imaging device.

13. The work vehicle of claim 7, wherein the first imaging device is mounted to the frame of the work vehicle at a first location, and the second imaging device is mounted to the frame of the work vehicle at a second location.

14. The work vehicle of claim 13, wherein the controller is configured to determine whether the first imaging device has a field of view including the area of interest at any given time throughout the trajectory of movement of the second portion, and further to select image data from the first imaging device at all times when the respective field of view includes the area of interest.

15. The work vehicle of claim 13, wherein the controller is configured to determine whether the first imaging device has a field of view including the area of interest at any given time throughout the trajectory of movement of the second portion, and further to activate the first imaging device at all times when the field of view of the first imaging device includes the area of interest and to deactivate the first imaging device and activate the second imaging device at all times when the field of view of the first imaging device does not include the area of interest.

16. The work vehicle of claim 7, wherein the first imaging device is mounted to the first portion of the work vehicle, and the second imaging device is mounted to the second portion of the work vehicle.

17. The work vehicle of claim 16, wherein the controller is configured to determine whether the first imaging device has a field of view including the area of interest at any given time throughout the trajectory of movement of the second portion, and further to select image data from the first imaging device at all times when the respective field of view includes the area of interest.

18. The work vehicle of claim 16, wherein the controller is configured to determine whether the first imaging device has a field of view including the area of interest at any given time throughout the trajectory of movement of the second portion, and further to activate the first imaging device at all times when the field of view of the first imaging device includes the area of interest and to deactivate the first imaging device and activate the second imaging device at all times when the field of view of the first imaging device does not include the area of interest.

19. The work vehicle of claim 16, wherein the second imaging device comprises a zoom lens, and the controller is further configured to automatically adjust a zoom setting based at least in part on a current position of the second imaging device along the trajectory of movement of the second portion of the work vehicle.

20. The work vehicle of claim 19, wherein the second imaging device is coupled to the second portion of the work vehicle via a rotatable mount, and the controller is further configured to automatically adjust rotation and accordingly an orientation of the second imaging device based at least in part on a current position of the second imaging device along the trajectory of movement of the second portion of the work vehicle.
